(19) United States
(12) Patent Application Publication
(10) Pub. No.: US 2009/0029242 A1
(43) Pub. Date: Jan. 29, 2009

(54) BATTERY PACK

(76) Inventor: Yasushi Hirakawa, Osaka (JP)

Correspondence Address: MCDERMOTT WILL & EMERY LLP, 600 13TH STREET, NW, WASHINGTON, DC, 20005-3096, US

(21) Appl. No.: 12/064,593

(22) PCT Filed: Jun. 20, 2006
(86) PCT No.: PCT/JP2006/312295

§ 371 Date: Aug. 4, 2008

(30) Foreign Application Priority Data
Aug. 23, 2006 (JP) 2005-242095

(51) Int. Cl. H01M 2/14

(52) U.S. Cl. 429/129

(57) ABSTRACT

A battery pack (21) includes a cell contained therein, the cell having a configuration in which an electrode assembly (4) including a positive electrode plate (1), a negative electrode plate (2), and a separator (3) is contained in a cell case (6), one of the electrodes being electrically connected to the cell case, the other electrode being electrically connected to a cell terminal. The battery pack includes a pack case (14) composed of a conductive member. The pack case (14) is electrically connected to the cell terminal (27), and an insulator is interposed between the pack case and the cell. Thereby, such a battery pack is achieved that, when an external physical shock which can deform a cell contained therein is applied to the battery pack, the damage can be minimized in an inexpensive manner without reducing the volume energy density.

### TECHNICAL FIELD

The present invention relates to a battery pack capable of ensuring safety from an external physical shock.

### BACKGROUND ART

In recent years, with the diversification of electronic devices, there is a demand for cells and battery packs with high capacity, high voltage, high output power, and improved safety. In particular, as means for providing safe batteries, a safety circuit is generally installed in battery packs. Furthermore, a thermal fuse and PTC for preventing an increase in cell temperature, protection means for sensing internal cell pressure and interrupting current, and the like are provided in cells.

However, when an external physical shock is applied to a battery pack and cells, they are deformed or broken, and a short circuit between positive and negative electrodes may occur instantaneously inside the cell. In such a case, even when the conventional protection means are provided, it is difficult to allow the protection function to work properly so as to follow the abrupt increase in temperature. Hence, the temperature of the cell may increase, or a gas may be generated.

As a method for preventing such a phenomenon, a method is contemplated in which, when an external physical shock which can deform a cell is applied, the positive and negative electrodes are short-circuited outside the cell before the positive and negative electrodes are short-circuited inside the cell, whereby the electric energy inside the cell case is reduced.

For example, a technique for improving safety has been proposed (see Patent Documents 1 and 2). Specifically, a conductive member in electrical contact with one of the electrodes is laminated through an insulating member on the outer circumferential portion of the cell case in electrical contact with the other electrode. In this manner, when an external physical shock is applied, the insulating member is broken through, so that a short-circuit occurs outside the cell.

Patent Document 1: Japanese Patent Application Laid-Open No. 09-274934.

Patent Document 2: Japanese Patent Application Laid-Open No. 11-204096.

### DISCLOSURE OF THE INVENTION

### Problems to be Solved by the Invention

However, in the cells described in Patent Documents 1 and 2, the conductive member for causing an external short-circuit is laminated or wound on each cell. Therefore, the cost is high, and the productivity is low. Moreover, the volume ratio of the power generation elements to the cell is reduced. This results in a disadvantage in increasing the capacity and, in a battery pack constituted by a plurality of cells, leads to a reduction in volume energy density and weight energy density, thus causing problems.

Accordingly, the present invention has been made in view of the above conventional problems, and it is an object of the invention to provide a battery pack in which, even when an external physical shock which can deform a cell contained therein is applied to the battery pack, the damage can be minimized in an inexpensive manner without reducing the volume energy density.

### Means for Solving the Problems

In order to achieve the above object, a battery pack of the present invention includes a cell contained therein, the cell having a configuration in which an electrode assembly including a positive electrode plate, a negative electrode plate, and a separator is contained in a cell case, one of the electrodes being electrically connected to the cell case, the other electrode being electrically connected to a cell terminal. The battery pack includes a pack case composed of a conductive member, wherein the pack case is electrically connected to the cell terminal, and an insulator is interposed between the pack case and the cell.

In the battery pack of the present invention, a conductive member of each cell is eliminated, and the pack case is used in which the function of the conductive member is integrated with the enclosing function of the battery pack. In this manner, a reduction in volume energy density of the battery pack can be prevented, and the safety of the battery pack is further improved through the heat dissipation effect of the pack case itself particularly when heat is generated due to cell abnormality. In addition, since the conductive member is not used in each cell, an increase in the number of components and the number of processing steps can be restrained, and therefore an increase in cost can be restrained.

### BRIEF DESCRIPTION OF THE DRAWINGS

FIG. 1 is a cross-sectional view of a battery pack of example 1 of the present invention.

FIG. 2 is an outside view of a battery module used in the battery pack.

FIG. 3 is an outside view of the battery pack of example 1.

FIG. 4 is an outside view of a battery pack of example 2 of the present invention.

FIG. 5 is a cross-sectional view of the battery pack of example 2.

FIG. 6 is an outside view of a battery pack of example 3 of the present invention.

FIG. 7 is a cross-sectional view of the battery pack of example 3.

FIG. 8 is an outside view of a battery pack of example 4 of the present invention.

FIG. 9 is a cross-sectional view of the battery pack of example 4.

FIG. 10 is a cross-sectional view of a battery pack of a comparative example of the present invention.

FIG. 11 is a cross-sectional view of a cell of the present invention.

### BEST MODE FOR CARRYING OUT THE INVENTION

A battery pack of the present invention includes a cell contained therein. The cell has a configuration in which an electrode assembly including a positive electrode plate, a negative electrode plate, and a separator is contained in a cell case. One of the electrodes is electrically connected to the cell case, and the other electrode is electrically connected to a cell terminal. The battery pack includes a pack case composed of a conductive member. The pack case is electrically connected to the cell terminal, and an insulator is interposed between the pack case and the cell.

In the battery pack with the present configuration, when an external physical shock is applied, the insulator interposed between the pack case and the cell case is broken to cause a short-circuit before the positive and negative electrodes are short-circuited inside the cell, whereby an increase in the temperature of the cell can be avoided. A metal material such as iron, nickel, aluminum, or copper may be used as the conducting member used for the pack case of the present invention. In particular, aluminum is more preferably used in terms of electrical resistance and reduction in weight. Moreover, the conductive member may have a cutout portion in a part thereof and may be a stripe-like shape, a lattice-like shape, or the like.

In the present invention, the insulator interposed between the pack case and the cell may be formed as a pack-insulator on the inner circumferential surface of the pack case or as a cell case-insulator on the outer circumferential surface of the cell case or may be interposed on both the surfaces.

As a method for forming the insulator as the pack-insulator on the inner surface of the pack case, a commonly used method can be used in which the insulator is directly formed on the inner circumferential surface of the pack case by means of bonding, printing, coating, spraying, dipping, or the like. Furthermore, a method may be used in which the frame or component of the pack-insulator is formed in advance and is inserted into and attached to the pack case. Moreover, the pack case can be produced by forming the conductive member on the outer circumferential surface of the pack-insulator produced in advance. In this case, the conductive member can be obtained by means of vapor deposition, plating, or the like. Preferably, the pack-insulator has a heat-proof temperature of preferably 100° C. or more. This is because, when the pack-insulator melts or deteriorates due to the temperature increase of the cell, the short-circuiting effect may not be obtained. Examples of the material for the pack-insulator include polyolefin-based resins such as polyethylene and polypropylene and ester-based resins such as polycarbonate. Of these, polycarbonate is preferred in terms of workability and the like.

Meanwhile, when the insulator is formed as the cell case-insulator on the outer circumferential surface of the cell case, an advantage is obtained in that an accidental short-circuit can be prevented during operations performed after the production of the cell is completed and until the cell is contained in the battery pack. As a method for forming the cell case-insulator on the outer circumferential surface of the cell case, the following methods, for example, may be used: a method in which an insulative film is wound on the outer circumferential surface of the cell case; and a method in which an insulative material is applied to the outer circumferential surface of the cell. A heat shrinkable resin is preferably used as the material for the cell case-insulator, and examples of such a material include polyolefin-based resins.

When the insulator is formed on both the pack case and the cell case, the same effect is obtained as a matter of course. In the battery pack of the present invention, the thickness of the pack case is preferably 100 μm to 500 μm, and the total thickness of the insulator is preferably 50 μm to 400 μm. This is because, when the thickness is 50 μm or less, it is difficult to provide insulation under normal conditions and because, when the thickness is 400 μm or more, the insulator may not be reliably broken when a physical shock is generated.

In the present invention, the pack-insulator may be formed on a part of the inner circumferential surface of the pack case. The method for partially forming the insulator can take various forms depending on the function of the insulator. For example, when only the pack-insulator is applied as the insulator, the pack-insulator may be provided on at least a contact portion between the cell and the pack case in order to exert the insulating function efficiently. When both the pack-insulator and the cell case-insulator are used as the insulator, high capacity can be achieved without reducing the volume occupation ratio of the cell by interposing the pack-insulator into a space portion in the pack case containing the cell. In the configuration in which the pack-insulator is partially disposed, when the cell is inserted into the pack case, a positioning effect is obtained. In addition to this, since the cell can be secured inside the pack case during use, battery failure due to vibration can be avoided.

The battery pack of the present invention is characterized in that an insulating member is formed on the outer circumferential surface of the pack case. By forming the insulating member on the outer circumferential surface of the pack case, an external short-circuit can be prevented during operations performed during production of the battery pack and until the battery pack is installed in an electronic device. Moreover, this insulating member is not necessarily formed on the entire outer circumferential surface of the battery pack and may be formed on a part thereof. In such a case, it is preferable that the same material be used for the pack-insulator and the insulating member on the outer circumferential surface and that they form a structure continuous through the cutout portion of the pack case. In particular, when insert molding is used, the pack-insulator can be easily provided.

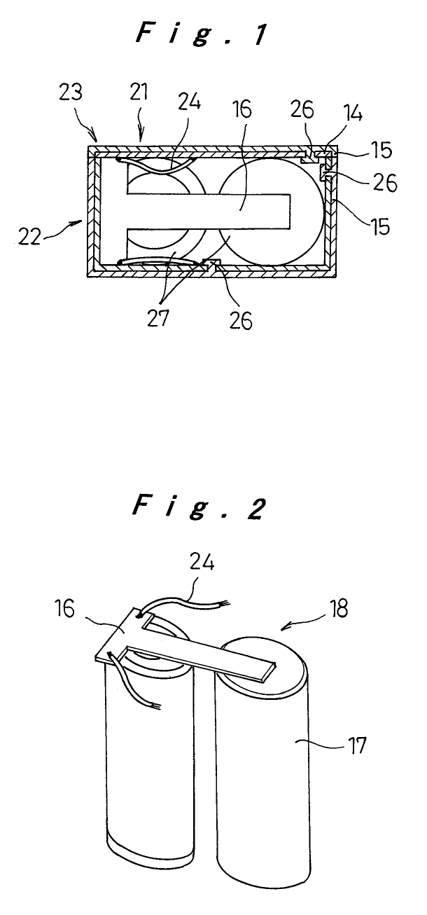

FIG. 1 shows a battery pack having two cylindrical 18650 size lithium ion rechargeable batteries connected in series. The battery pack 21 includes a battery-containing portion 22 having a pack case 14 in which a conductive member such as iron, nickel, aluminum, or copper is used, and a pack lid. An insulating member 15 is formed on the outer circumferential surface of the pack case 14, and a pack-insulator 26 is formed on the inner circumferential surface thereof. The battery pack 21 contains a battery module 18 shown in FIG. 2. In the battery module 18, a cell case-insulator 17 is wound on each cell, and a connection plate 16 is welded to each cell terminal 27. This connection plate 16 is electrically connected to the pack case 14 through a connection lead 24.

Hereinbelow, embodiments of the present invention will be described.

### EXAMPLE 1

FIG. 11 is a cross-sectional view of a lithium ion rechargeable battery. In the lithium ion rechargeable battery, a positive electrode plate 1 having a positive electrode active material layer applied to a strip-like positive electrode collector and a negative electrode plate 2 having a negative electrode active material layer applied to a strip-like negative electrode collector are wound in a spiral shape with a separator 3 interposed therebetween and constitute an electrode assembly 4. The electrode assembly 4 and an electrolyte solution are contained in a cell container 5. The separator 3 is also disposed between the outermost circumference of the electrode assembly 4 and the inner circumferential surface of a cell case 6, and the end portions of the separator 3 protrude outwardly from the upper and lower edges of the active material-applied portions of the positive electrode plate 1 and the negative electrode plate 2. The cell container 5 includes the cylindrical cell case 6 serving as a negative terminal and a cell lid 7 serving as a positive terminal. The cell container 5 is sealed by clamping the upper opening of a side circumferential portion 6a of the cell case 6 onto the outer circumference of the plate-like cell lid 7 through an insulative gasket 8. The reference numeral 6b represents a recessed groove provided for clamping the insulative gasket 8 onto the circumference of the side circumferential portion 6a of the cell case 6. The reference numeral 6c represents a top outer edge portion bent for clamping the insulative gasket 8. This insulative gasket 8 electrically insulates the cell case 6 from the cell lid 7. One end of a positive electrode lead 10 is welded to the positive electrode plate 1, and the other end is welded to the cell lid 7. Hence, the positive electrode plate 1 is electrically connected to the cell lid 7. One end of a negative electrode lead 11 is welded to the negative electrode plate 2, and the other end is welded to a bottom portion 6d of the cell case 6. Hence, the negative electrode plate 2 is electrically connected to the cell case 6. An upper insulating plate 12 is interposed between the electrode assembly 4 and the cell lid 7, and a bottom insulating plate 9 is interposed between the electrode assembly 4 and the bottom portion 6d of the cell case 6.

In example 1, lithium hexafluorophosphate (LiPF₆) serving as a solute was dissolved in a mixed solvent of ethylene carbonate (EC) and diethyl carbonate (DEC), prepared by mixing them in a volume ratio of 1:1, at a concentration of 1 mol/dm³, and the mixture was used as an electrolyte solution. A positive electrode mixture was prepared by mixing LiMn₂O₄, acetylene black serving as a conductive agent, and polyvinylidene fluoride serving as a binding agent at a weight ratio of 92:3:5. LiMn₂O₄ was prepared by mixing electrolytic manganese dioxide (MnO₂) and lithium carbonate (Li₂CO₃) such that Li/Mn=1/2 and firing the mixture in air at 800° C. for 20 hours. Since the positive electrode mixture was kneaded to a paste, a solution of polyvinylidene fluoride serving as a binding agent dissolved in n-methyl pyrrolidone (NMP) serving as a solvent was used. Note that the above mixing ratio is the ratio of solid contents. The paste containing the positive electrode active material was applied to both sides of a positive electrode collector formed from an aluminum foil having a thickness of 15 μm to form the positive electrode active material layer, whereby the positive electrode plate 1 was produced. Subsequently, the positive electrode plate 1 was pressed such that the thickness thereof was reduced to 200 μm. A negative electrode mixture was prepared by mixing artificial graphite and styrene-butadiene rubber (SBR) serving as a binding agent at a weight ratio of 97:3. Since the negative electrode mixture was kneaded to a paste, an aqueous dispersion solution of styrene-butadiene rubber serving as a binding agent was used. Note that the above mixing ratio is the ratio of solid contents. The paste containing the negative electrode active material was applied to both sides of a negative electrode collector formed from a copper foil having a thickness of 14 μm to form the negative electrode active material layer, whereby the negative electrode plate 2 was produced. Subsequently, the negative electrode plate 2 was pressed such that the thickness thereof was reduced to 170 μm. The obtained cell was covered with a heat shrinkable tube serving as the cell case-insulator 17 made of polyethylene terephthalate and having a thickness of 80 μm such that the top outer edge portion 6c was covered therewith, and the heat shrinkable tube was heat-shrunk using warm air at 90° C., whereby the completed battery was obtained.

Next, as shown in FIG. 2, the completed two cylindrical lithium ion rechargeable batteries were connected in series through the nickel-made connection plate 16 having a thickness of 0.2 mm. Then, the connection lead 24 for providing electrical connection to the pack case 14 constituting the battery pack was attached to the connection plate 16, whereby the battery module 18 was produced.

FIG. 3 shows the outside view of the battery pack of example 1. In example 1, an aluminum plate of 0.2 mm was used for the conductive member used as the pack case 14. In the aluminum plate of the battery-containing portion 22, a space portion not in direct contact with the cell was punched to form eight holes with a diameter of 3 mm each serving as the cutout portion of the aluminum plate. Similarly, in the aluminum plate of the pack lid 23, a space portion not in direct contact with the cell was punched to form four holes with a diameter of 3 mm each serving as the cutout portion of the aluminum plate. Subsequently, the insulating member 15 made of a polycarbonate resin (flame-resisting UL94V-0 class) and having a thickness of 0.15 mm was formed on the outer circumferential surface of each of the aluminum plates by means of insert molding. At the same time, the pack-insulators 26 having a diameter of 4 mm and a thickness of 0.15 mm were molded in a space portion on the inner surface of the aluminum plates. In this structure, the pack-insulators 26 and the insulating member 15 are connected to each other through the cutout portions of the aluminum plates.

Next, the connection lead 24 was electrically connected to the pack cases 14 of the battery-containing portion 22 and the pack lid 23 from the positive electrode side of the battery module 18. Thereafter, the battery-containing portion 22 and the pack lid 23 were ultrasonically welded, whereby the battery pack 21 was produced. At this time, the battery module was in a state charged at 4.2 V.

### EXAMPLE 2

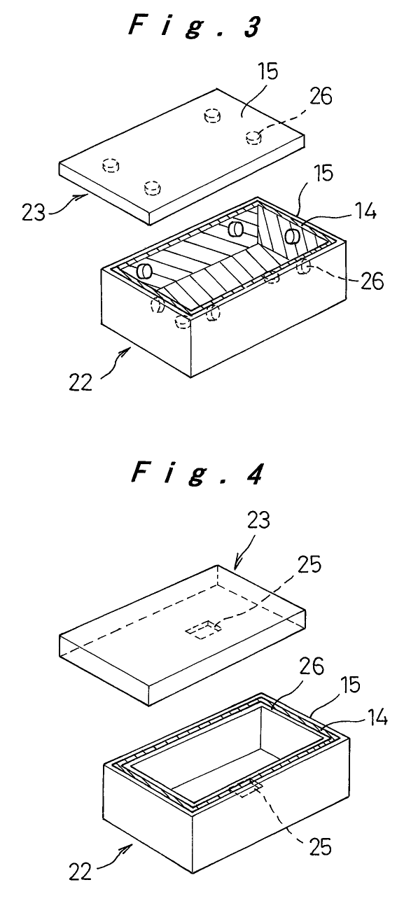

As shown in FIG. 4, the pack-insulator 26 was formed by the method similar to that in example 1, except that the conductive member remains exposed on conductive member-exposed portions 25 which have a size of 5 mm×5 mm and are formed on the inner surfaces of the pack cases composed of the pack lid 23 and the battery-containing portion 22. In this structure, the pack-insulator 26 and the insulating member 15 were connected through the cutout portions of the aluminum plates. Subsequently, the positive electrode side of the battery module 18 was electrically connected to the conductive member-exposed portions 25 through the connection lead 24, whereby the battery pack of example 2 was produced. FIG. 5 shows a cross-section of the battery pack of example 2.

### EXAMPLE 3

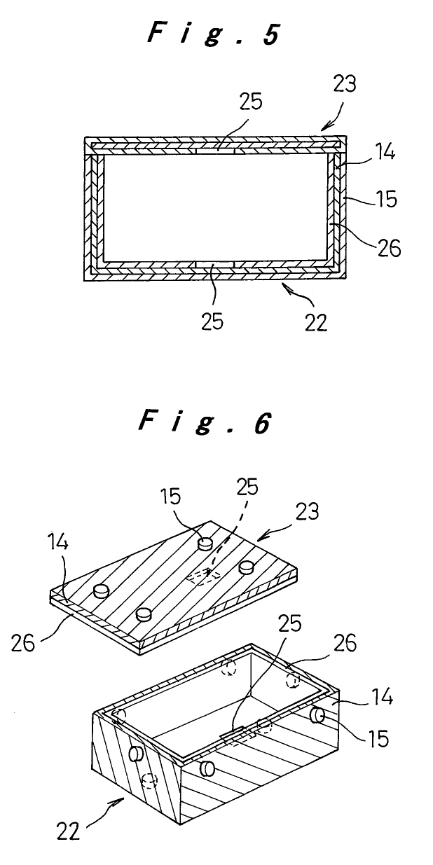

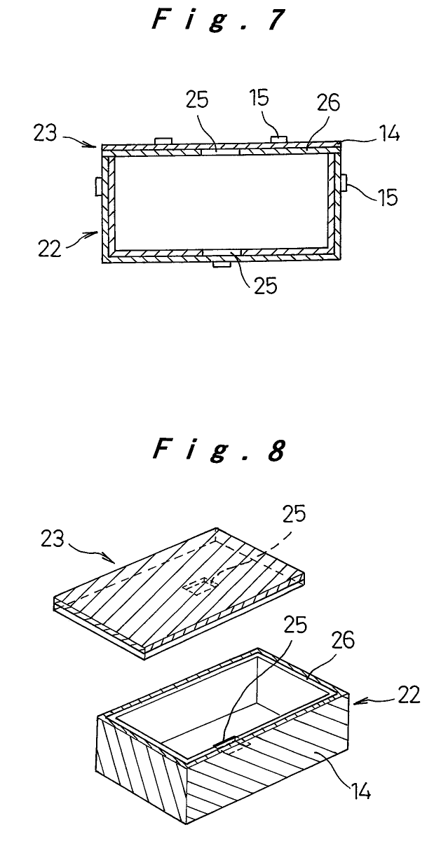

As in example 2, the pack-insulator was formed on the inner surface of each of the battery-containing portion 22 and the pack lid 23 constituting the battery pack 21, except for the conductive member-exposed portions 25 having a size of 5 mm×5 mm. At the same time, the insulating members 15 having 4 mm φ were molded on the outer circumferential surface, and the pack-insulator 26 and the insulating members 15 were connected to each other through the cutout portions of the aluminum plates. Thereafter, the positive electrode side of the battery module 18 was electrically connected to the conductive member-exposed portions 25 by using the connection lead 24, whereby the battery pack of example 3 was produced. FIG. 6 shows an outside view of the battery pack of example 3, and FIG. 7 shows a cross-sectional view of the battery pack.

### EXAMPLE 4

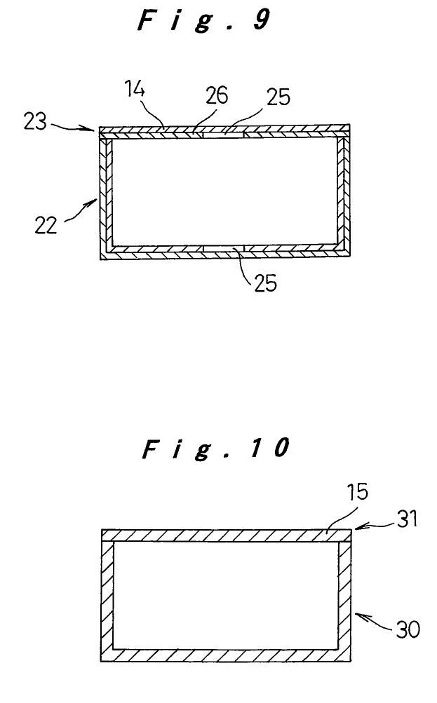

As shown in FIG. 8, a polycarbonate resin-made pack-insulator 26 having a hole of 5 mm×5 mm was injection molded to have a thickness of 0.15 mm. This pack-insulator was inserted into the battery-containing portion 22 in which an aluminum plate was used as the pack case 14. Subsequently, the positive electrode side of the battery module 18 was electrically connected to the conductive member-exposed portions 25 by using the connection lead 24, whereby the battery pack of example 4 was formed. FIG. 9 shows a cross-sectional view of this battery pack.

### EXAMPLE 5

A battery pack was produced as in example 4 except that the cell case-insulator 17 was not provided on the outer circumference of the cell case 6, and this battery pack was used as the battery pack of example 5 (not shown).

### EXAMPLE 6

A battery pack was produced as in example 4 except that the pack-insulator 26 was not inserted into the battery-containing portion 22, and this battery pack was used as the battery pack of example 6 (not shown).

### COMPARATIVE EXAMPLE

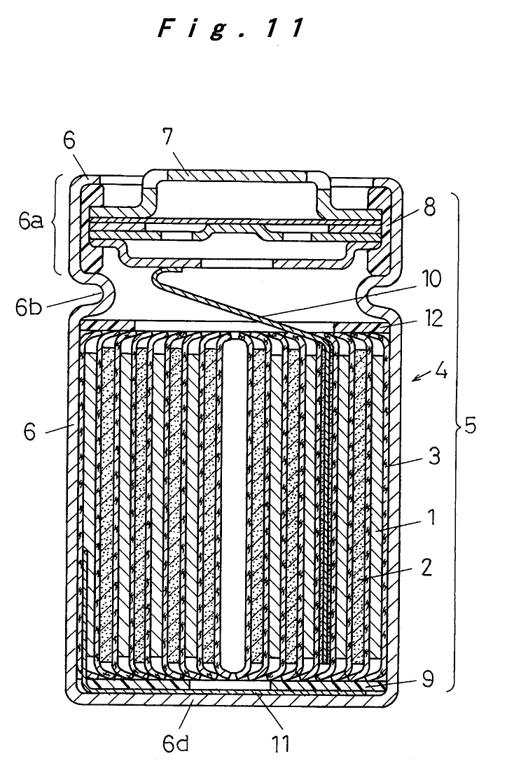

An insulating member 15 formed by injection molding polycarbonate resin (flame-resisting UL94V-0 class) and having a thickness of 0.35 mm was used as a battery-containing portion 30 and a pack lid 31, and a battery module 18 the same as that used in example 1 was incorporated inside the insulating member 15. This was used as the battery pack of a comparative example. The cross-sectional view of the battery pack of the comparative example is shown in FIG. 10.

The battery packs obtained in the above examples and comparative example were evaluated as follows.

### (A) Nail Penetration Test

Ten completed battery packs were used, and an iron-made nail having a diameter of 2 mm pierced each battery pack so as to pass through the longitudinal and radial center of one of the cells in the battery pack at a velocity of 5 mm per second and at ambient temperatures of 20° C. and 40° C. Then, the damage of the battery pack due to the heat generation of the cell and the blowout of gas from the cell were observed. The results are shown in Table 1.

TABLE 1

| | | Example | Example | Example | Example | Example | Example | Comparative |
|---|---|---|---|---|---|---|---|---|
| | | 1 | 2 | 3 | 4 | 5 | 6 | example |
| 20° C. | Melting | No | No | No | No | No | No | No |
| | Blowout | No | No | No | No | No | No | No |
| | of gas | | | | | | | |
| 40° C. | Melting | No | No | No | No | No | No | Yes |
| | Blowout | No | No | No | No | No | No | Yes |
| | of gas | | | | | | | |

### (B) Crush Test

By using an iron-made round bar with a diameter of 10 mm, ten completed battery packs were crushed along the longitudinal direction of the round bar at ambient temperatures of 20° C. and 40° C. and at a velocity of 50 mm per second until the thickness of each battery pack was reduced to 50% or less of the initial thickness. At this time, the longitudinal position of the round bar was perpendicular to the longitudinal direction of the two cells in the battery pack. The battery pack was crushed at the longitudinal center position of the cells. At this time, the melting of the battery pack due to the heat generation of the cell and the blowout of gas from the cells were observed. The results are shown in Table 2.

TABLE 2

| | | Example | Example | Example | Example | Example | Example | Comparative |
|---|---|---|---|---|---|---|---|---|
| | | 1 | 2 | 3 | 4 | 5 | 6 | example |
| 20° C. | Melting | No | No | No | No | No | No | No |
| | Blowout | No | No | No | No | No | No | No |
| | of gas | | | | | | | |
| 40° C. | Melting | No | No | No | No | No | No | Yes |
| | Blowout | No | No | No | No | No | No | Yes |
| | of gas | | | | | | | |

As shown in Tables 1 and 2, in the cases where the pack case 14 composed of the conductive member was used for the battery pack 21 (examples 1 to 6), the resin portion of the battery pack did not melt due to heat generation in the cells, and the blowout of gas was not observed, irrespective of the ambient temperature. However, in the cases in which the pack case 14 was not used in the battery pack (comparative example), the battery pack was damaged when the ambient temperature was high. This may be because, since the ambient temperature contributes to the temperature increase of the cells when the ambient temperature is high, the battery pack was melted and the blowout of gas occurred. As described above, even when an external physical shock which can deform the battery pack and the cells is applied under high ambient temperature conditions, by using the pack case 14 composed of the conductive member in the battery pack, the pack case and the cell case are short-circuited before a short-circuit inside the cell occurs, whereby electric energy is consumed outside the cell case. Accordingly, the safety of the cells can be ensured without inducing abnormal reaction associated with an abrupt increase in temperature due to a short-circuit inside the cell.

### INDUSTRIAL APPLICABILITY

As has been described, the present invention can provide a low cost battery pack which is excellent in safety and reliability even when a physical shock, which can cause deformation of the battery pack and the cells, is applied to the battery pack, and which does not reduce the volume energy density.

1. A battery pack comprising a cell contained therein, the cell having a configuration in which an electrode assembly including a positive electrode plate, a negative electrode plate, and a separator is contained in a cell case, one of the electrodes being electrically connected to the cell case, the other electrode being electrically connected to a cell terminal, the battery pack comprising a pack case composed of a conductive member, wherein the pack case is electrically connected to the cell terminal and an insulator is interposed between the pack case and the cell case, whereby a short-circuit of the cell occurs when the insulator is broken.

2. The battery pack according to claim 1, wherein a cutout portion is provided in the pack case.

3. The battery pack according to claim 1, wherein the insulator is a pack-insulator formed on an inner circumferential surface of the pack case.

4. The battery pack according to claim 3, wherein the pack-insulator is formed on a part of the inner circumferential surface of the pack case.

5. The battery pack according to claim 1, wherein the insulator is a cell case-insulator formed on an outer circumferential surface of the cell case.

6. The battery pack according to claim 1, wherein the insulator is a pack-insulator formed on an inner circumferential surface of the pack case and a cell case-insulator formed on an outer circumferential surface of the cell case.

7. The battery pack according to claim 6, wherein the pack-insulator is formed on a part of the inner circumferential surface of the pack case.

8. The battery pack according to claim 3, wherein the pack-insulator is provided so as to fill at least a space portion between the pack case and the cell.

9. The battery pack according to claim 1, wherein an insulating member is formed on an outer circumferential surface of the pack case.

10. The battery pack according to claim 9, wherein the pack-insulator and the insulating member are made of the same material and are configured so as to be continuous through a cutout portion provided in the pack case.
